(19) United States
(12) Patent Application Publication
(10) Pub. No.: US 2026/0115072 A1
(43) Pub. Date: Apr. 30, 2026

(54) SIDE RAIL ASSEMBLY AND METHODS OF USE

(71) Applicant: Sizewise Rentals, L.L.C., Eden Prairie, MN (US)

(72) Inventors: Michael Andrew VERHAGEN, Heartland, WI (US); David Delroy DRISCOLL, JR., Milwaukee, WI (US); Alexandria MILLER, Muskego, WI (US); John SPRINGER, Milwaukee, WI (US); Kenneth Scott BOWER, Santa Ana, CA (US); Scott M. HARVEY, Plymouth, MN (US); Kristen THURMAN, Tempe, AZ (US)

(73) Assignee: Sizewise Rentals, L.L.C., Eden Prairie, MN (US)

(21) Appl. No.: 19/044,563

(22) Filed: Feb. 3, 2025

Related U.S. Application Data
(60) Provisional application No. 63/549,118, filed on Feb. 2, 2024.

(51) Int. Cl. A61G 7/05

(52) U.S. Cl. CPC A61G 7/0509; A61G 7/0513; A61G 7/0516

(57) ABSTRACT

A side rail assembly may include a support rail connected to a medical bed, the support rail may include a slot disposed along an exterior surface the support rail and one or more indents positioned within the slot. The side rail assembly may include a carrier slidably connected to the support rail, wherein the carrier comprising a guide pin configured to slidably abut the slot. A side rail assembly may further include a side rail being rotatably connected to the carrier, wherein the guide pin is urged into the one or more indents when the guide pin is aligned with the one more indents, thereby allowing rotation of the side rail to a raised position and restricting movement of carrier along the support rail. Methods for moving the side rail and triggering a magnetic sensor are disclosed herein.

### CROSS REFERENCE TO RELATED APPLICATIONS

This U.S. non-provisional patent application claims priority to U.S. Provisional Patent Application 63/549,118, filed Feb. 2, 2024. The contents of the identified earlier-filed application is hereby incorporated by reference into the present application.

### FIELD OF THE DISCLOSED SUBJECT MATTER

The disclosed subject matter generally relates to side rails for beds, and more particularly, but not necessarily exclusively, to movable side rail assemblies for medical beds.

### SUMMARY

In some aspects, the disclosed subject matter described herein relates to a side rail assembly for a medical bed including: a support rail connected to the medical bed, the support rail including: a slot disposed along an exterior surface the support rail; and one or more indents positioned within the slot; a carrier slidably connected to the support rail, the carrier including a guide pin configured to slidably abut the slot; and a side rail connected to the carrier, wherein the guide pin is urged into the one or more indents when the guide pin is aligned with the one more indents, thereby allowing rotation of the side rail to a raised position and restricting movement of the carrier along the support rail.

In some aspects, the disclosed subject matter described herein relates to a side rail connected to a medical bed, wherein the side rail transitions to and from a head position and a foot position in a linear motion.

In some aspects, the disclosed subject matter described herein relates to a side rail assembly, further including a hinge connected between the carrier and the side rail, the hinge configured to rotate between a raised position and a lowered position.

In some aspects, the disclosed subject matter described herein relates to a side rail assembly, wherein the hinge includes: a top arm having a first latch; and a bottom arm having a second latch rotatably connected to the bottom arm, wherein the second latch is configured to engage the first latch when the hinge is rotated into the raised position.

In some aspects, the disclosed subject matter described herein relates to a side rail assembly, the hinge further includes a pulling member configured to rotate the second latch away from the first latch.

In some aspects, the disclosed subject matter described herein relates to a side rail assembly, wherein a torsional element is connected between the carrier and the bottom arm, wherein the torsional element is configured to provide rotational resistance of the hinge when the hinge is moved from the raised position to the lowered position.

In some aspects, the disclosed subject matter described herein relates to a side rail assembly, further including a lock assembly including: a hub connected to the carrier, the hub having a central aperture; a rotor rotatably connected to an exterior surface of the hub, the rotor having one of a pair of helical slots and a pair of ramps; a pin assembly extending through the central aperture, the pin assembly configured to engage one of the pair of helical slots and the pair of ramps, whereby the rotation of the rotor about the hub moves the pin assembly within the hub outwardly and away from the carrier; and a spring configured to urge the pin assembly towards the carrier.

In some aspects, the disclosed subject matter described herein relates to a side rail assembly, wherein the rotation of the rotor is configured to compress the spring.

In some aspects, the disclosed subject matter described herein relates to a side rail assembly, wherein the lock assembly further includes a pin body connected to the guide pin within the hub, wherein when the hinge is prevented from rotating to the raised position when the guide pin is not aligned with the one or more indents.

In some aspects, the disclosed subject matter described herein relates to a side rail assembly, wherein the side rail includes a paddle assembly configured to rotate the rotor and unseat the guide pin from the one or more indents, thereby allowing movement of the carrier along the support rail.

In some aspects, the disclosed subject matter described herein relates to a side rail assembly, wherein the paddle assembly includes: a frame coupled the side rail, the frame having a first frame end and a second frame end opposite the first frame end; a central gear connected to the frame, the central gear having a set of teeth disposed along a circumference of the central gear; a first paddle having a first gear rack configured to engage the set of teeth, the first paddle slidably coupled to the frame at the first frame end; a second paddle having a second gear rack configured to engage the set of teeth opposite the first gear rack, the second paddle slidably coupled to the frame at the second frame end; and a cable connected between the central gear and the rotor, whereby rotation of the central gear urges rotation of the rotor, whereby movement of one of the first paddle and the second paddle rotates the central gear.

In some aspects, the disclosed subject matter described herein relates to a side rail assembly, wherein the paddle assembly further includes a rotating element configured to urge rotation of the central gear.

In some aspects, the disclosed subject matter described herein relates to a side rail assembly, wherein the rotating element includes one of a torsion spring and an axial spring.

In some aspects, the disclosed subject matter described herein relates to a side rail assembly, further including a magnetic sensor recessed into the support rail, the magnetic sensor configured to detect a magnetic field source connected to the carrier.

In some aspects, the disclosed subject matter described herein relates to a side rail assembly, wherein the magnetic sensor is positioned a predetermined distance from the one or more indents.

In some aspects, the disclosed subject matter described herein relates to a side rail assembly, further including cable tensioning element configured to adjust the tension of the cable between the central gear and the rotor.

In some aspects, the disclosed subject matter described herein relates to a side rail assembly for a medical bed including: a support rail connected to the medical bed, the support rail including: a slot disposed along an exterior surface the support rail; and one or more indents positioned within the slot; a carrier slidably connected to the support rail, the carrier including a guide pin configured to slidably abut the slot; and a side rail connected to the carrier, wherein the guide pin is urged into the one or more indents when the guide pin is aligned with the one more indents, thereby restricting movement of the carrier along the support rail.

In some aspects, the disclosed subject matter described herein relates to a method for moving a side rail, including the steps of: providing a medical bed having a support rail connected to at least one side of an upper frame of the medical bed; providing a side rail assembly connected between the support rail and a side rail, wherein the side rail assembly includes a carrier slidably coupled to the support rail; providing a pin assembly having a guide pin configured to abut the support rail, wherein the support rail includes one or more indents configured to receive the guide pin; aligning the guide pin with one of the one or more indents, thereby urging the guide pin into one of the one or more indents; and raising a hinge connected to the carrier, whereby the side rail is moved to a raised position.

In some aspects, the disclosed subject matter described herein relates to a method for moving a side rail, further including the step of engaging a first latch with a second latch, thereby locking the side rail in the raised position.

In some aspects, the disclosed subject matter described herein relates to a method for moving a side rail, further including the steps of: moving a pulling member connected to the second latch; disengaging the first latch from the second latch; and rotating a hinge downwardly from the raised position to a lowered position.

In some aspects, the disclosed subject matter described herein relates to a method for moving a side rail, further including the step of rotating a torsional element connected to the hinge.

In some aspects, the disclosed subject matter described herein relates to a method for moving a side rail, wherein the torsional element is a torsional damper, configured to control a rate of downward movement of the side rail from the raised position to the lowered position.

In some aspects, the disclosed subject matter described herein relates to a method for moving a side rail, further including the steps of moving the pin assembly out of the one or more indents, and pushing the side rail towards one of a head end and a foot end of the medical bed.

In some aspects, the disclosed subject matter described herein relates to a method for moving a side rail, further including the step of rotating a rotor having one of a helical slot and a ramp configured to urge the pin assembly out of the one or more indents.

In some aspects, the disclosed subject matter described herein relates to a method for moving a side rail, further including the steps of: providing a central gear connected to the side rail, the central gear having a cable connected to the rotor; and rotating the central gear, thereby urging the cable to rotate the rotor and move the pin assembly out of the one or more indents.

In some aspects, the disclosed subject matter described herein relates to a method for moving a side rail, further including the steps of: providing a first paddle having first gear rack linked to the central gear; proving a second paddle having a second gear rack linked to the central gear; and moving one of the first paddle and the second paddle towards the central gear, thereby rotating the central gear.

In some aspects, the disclosed subject matter described herein relates to a method of triggering a magnetic sensor, including the steps of: providing a support rail having a magnetic sensor; providing a carrier connected to the support rail, wherein the carrier includes a gap proximate the magnetic sensor; providing a bottom arm rotatably connected to the carrier, wherein the carrier includes a magnetic field source configured to rotate with the bottom arm; aligning the carrier with the magnetic sensor; rotating the bottom arm, thereby aligning the magnetic field source, the gap, and the magnetic sensor; and triggering the magnetic sensor with the magnetic field source.

### BRIEF DESCRIPTION OF THE DRAWINGS

The detailed description particularly refers to the accompanying figures, in which:

FIG. 1 is a perspective view of a medical bed in accordance with an embodiment of the disclosed subject matter.

FIG. 2 is a side view of a medical bed having a side rail in a raised head position in accordance with an embodiment of the disclosed subject matter.

FIG. 3 is a side view of a medical bed having a side rail in a lowered head position in accordance with an embodiment of the disclosed subject matter.

FIG. 4 is a side view of a medical bed having a side rail in a raised intermediate position in accordance with an embodiment of the disclosed subject matter.

FIG. 5 is a side view of a medical bed having a side rail in a lowered intermediate position in accordance with an embodiment of the disclosed subject matter.

FIG. 6 is a side view of a medical bed having a side rail in a raised foot position in accordance with an embodiment of the disclosed subject matter.

FIG. 7 is a side view of a medical bed having a side rail in a lowered foot position in accordance with an embodiment of the disclosed subject matter.

FIG. 8 is a cross-section view of a side rail assembly in a raised and locked position in accordance with an embodiment of the disclosed subject matter.

FIG. 9 is a cross-section view of a side rail assembly in a raised and unlocked position in accordance with an embodiment of the disclosed subject matter.

FIG. 10 is a cross-section view of a side rail assembly in a lowered and unlocked position in accordance with an embodiment of the disclosed subject matter.

FIG. 11 is a perspective view of a support rail in accordance with an embodiment of the disclosed subject matter.

FIG. 12 is a perspective view of a side rail assembly in accordance with an embodiment of the disclosed subject matter.

FIG. 13 is a cross-section view of a side rail assembly in accordance with an embodiment of the disclosed subject matter.

FIG. 14 is a perspective view of a pin assembly and rotor in accordance with an embodiment of the disclosed subject matter.

FIG. 15 is a side view of a side rail in accordance with an embodiment of the disclosed subject matter.

FIG. 16 is a perspective view of a paddle assembly in accordance with an embodiment of the disclosed subject matter.

FIG. 17 is a perspective view of a magnetic sensor configuration in accordance with an embodiment of the disclosed subject matter.

FIG. 18 is a perspective view of bottom arm having a housing in accordance with an embodiment of the disclosed subject matter.

FIG. 19 is a perspective view of a magnetic sensor embedded within a support rail in accordance with an embodiment of the disclosed subject matter.

FIG. 20 is a perspective view of a support bracket in accordance with an embodiment of the disclosed subject matter.

FIG. 21 is a perspective view of a support bracket and a magnetic sensor in accordance with an embodiment of the disclosed subject matter.

### DETAILED DESCRIPTION

As required, detailed aspects of the disclosed subject matter are disclosed herein; however, it is to be understood that the disclosed aspects are merely exemplary of the disclosed subject matter, which may be embodied in various forms. Therefore, specific structural and functional details disclosed herein are not to be interpreted as limiting, but merely as a basis for the claims and as a representative basis for teaching one skilled in the art how to variously employ the disclosed technology in virtually any appropriately detailed structure.

Although the disclosed subject matter has been disclosed with reference to various embodiments, it is understood that equivalents may be employed, and substitutions made herein without departing from the scope of the disclosed subject matter as recited in the claims.

Certain terminology will be used in the following description, and are shown in the drawings, and will not be limiting. For example, up, down, front, back, right, and left refer to the disclosed subject matter as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

The disclosed subject matter will now be described with reference to the drawing figures, in which like reference numerals refer to like parts throughout. For purposes of clarity in illustrating the characteristics of the present disclosed subject matter, proportional relationships of the elements have not been maintained in the figures. In some cases, the sizes of certain small components have been exaggerated for illustration.

Although the subject matter has been disclosed with reference to various particular embodiments, it is understood that equivalents may be employed and substitutions made herein without departing from the scope of the subject matter.

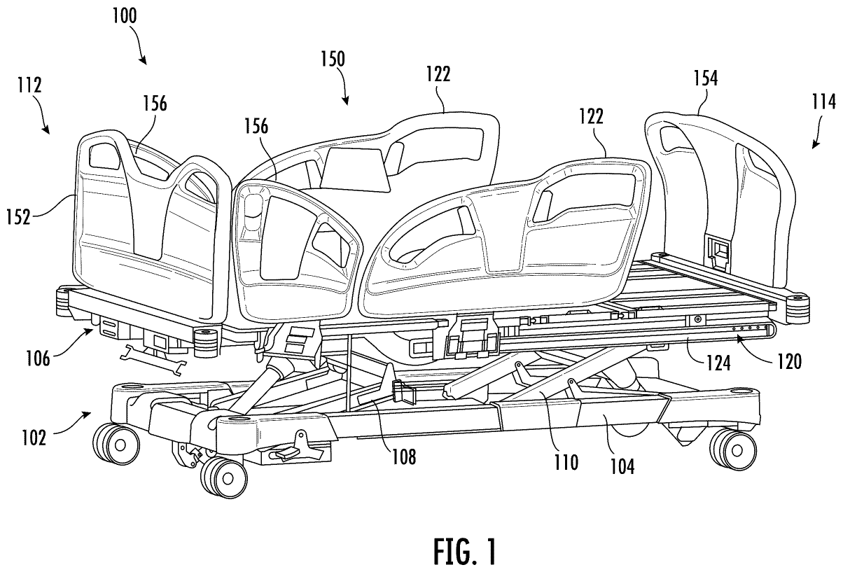

Referring to the drawings, FIG. 1 shows an embodiment of a medical bed 100 comprising a patient support assembly 102 having a lower frame 104 and an upper frame 106 movable relative to the lower frame 104. The upper frame 106 may be supported on two pair of lift arms 108 and 110, respectively. The lift arms 108 are positioned generally at a head end 112 of the lower frame 104, while the lift arms 110 are positioned generally at a foot end 114 of the lower frame 104. The medical bed 100 may comprise of a plurality of support rails 150 which may include one or more of a head rail 152, a foot rail 154, a pair of head side rails 156, and a pair of side rails 122. Reference to the head end 112 and the foot end 114 of the medical bed 100 is intended to provide an orientation reference and does not refer to any specific surface or element of the medical bed 100.

The medical bed 100 may comprise a pair of side rail assemblies 120 connected to the upper frame 106 and positioned generally towards the foot end 114 of the upper frame 106. The side rail assemblies 120 may be positioned on opposite sides of the upper frame 106 and may each be connected between the side rails 122 and the upper frame 106. The side rail assemblies 120 are configured to move the side rails 122 relative to the upper frame 106. The side rails 122 may be further configured to provide support to a patient during ingress or egress of the medical bed 100.

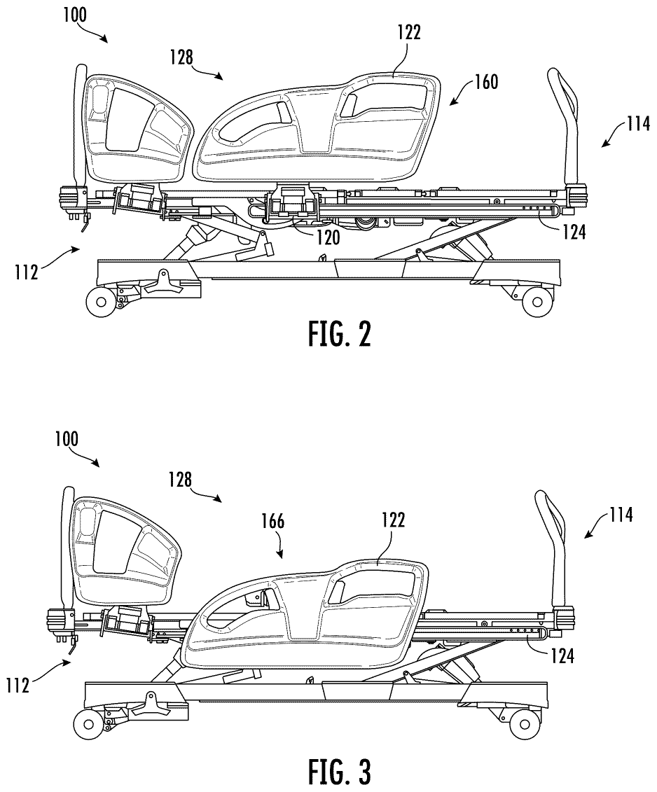

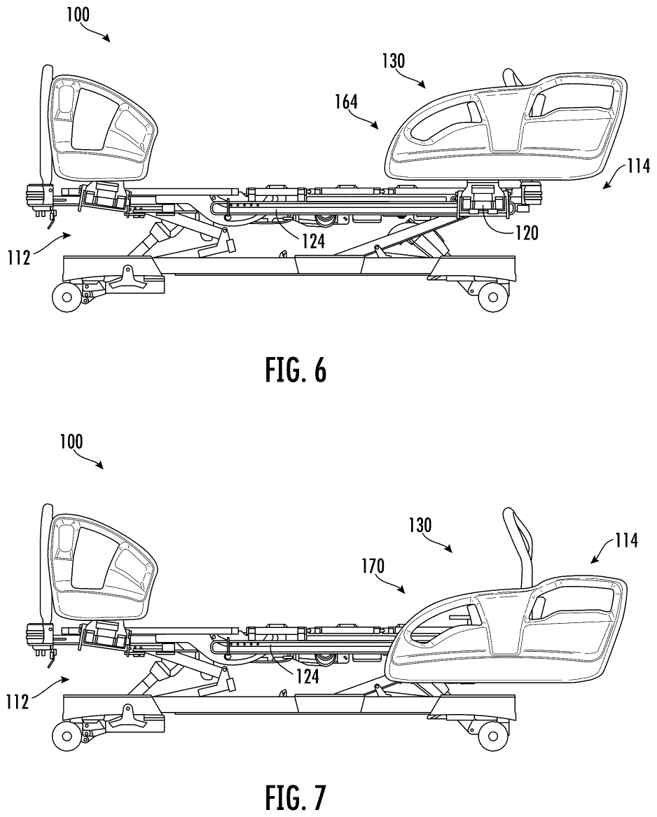

The side rail assemblies 120 may comprise a support rail 124 being generally liner in shape and connected to the upper frame 106 and a carrier 126 slidably connected to the support rail 124; whereby the carrier 126 may move along the support rail 124 in a linear motion or sliding motion from a head position 128 (shown in FIGS. 2-3) and a foot position 130 (shown in FIGS. 6-7). The side rails 122 may be configured to transition to and from the head position 128 and the foot position 130 in a linear motion. The side rail assemblies 120 are configured to restrict movement of the carrier 126 along the support rail 124 when the side rails 122 are in a raised position as discussed below.

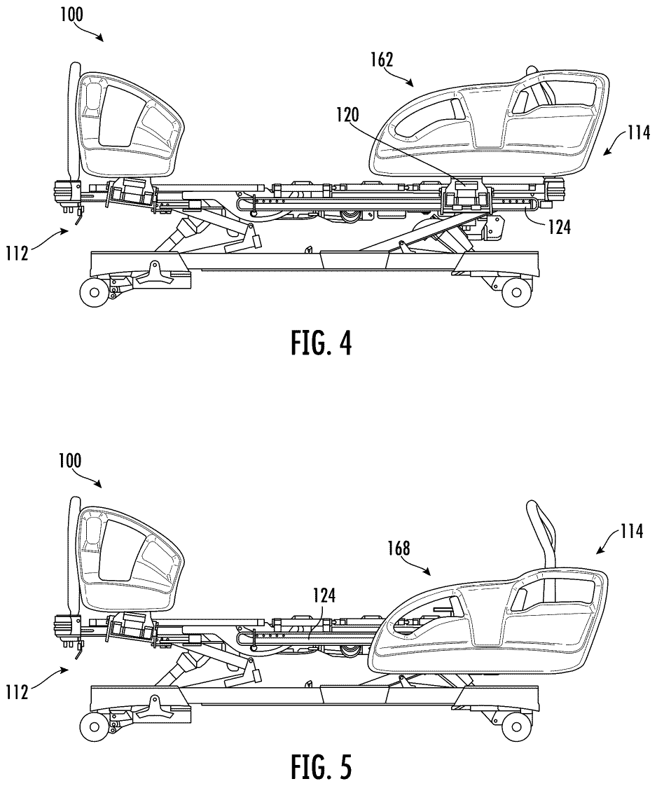

Referring to FIGS. 2-7, in an embodiment of the disclosed subject matter, the side rail assemblies 120 are configured to restrict longitudinal movement of the side rails 122 between the head end 112 and the foot end 114 when the side rails 122 are in one of a raised head position 160, a raised intermediate position 162, and a raised foot position 164. When the side rails 122 are in the raised head position 160, the raised intermediate position 162, or the raised foot position 164, the side rail assemblies are locked to the support rail 124 and cannot be slid along the support rail 124 until the side rails 122 are moved to one of a lowered head position 166, a lowered intermediate position 168, or a lowered foot position 170 respectively as described below.

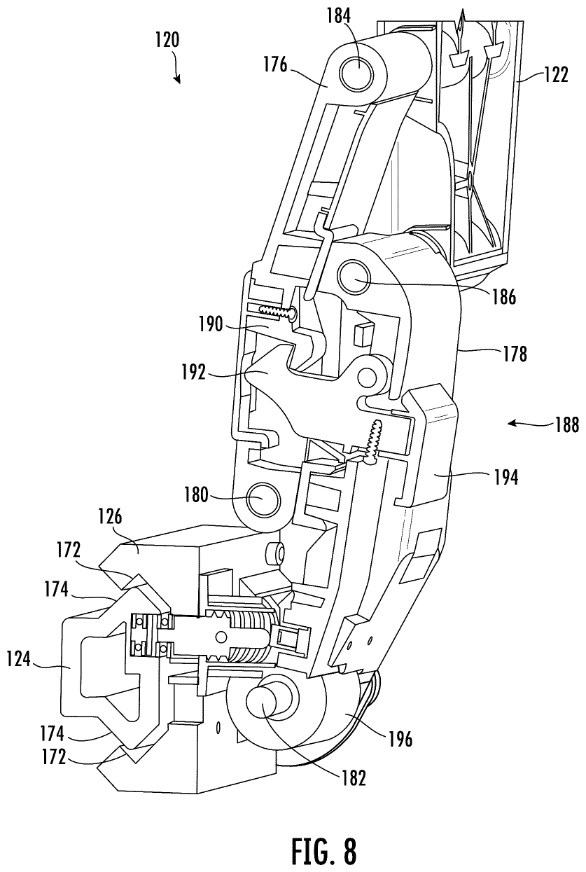

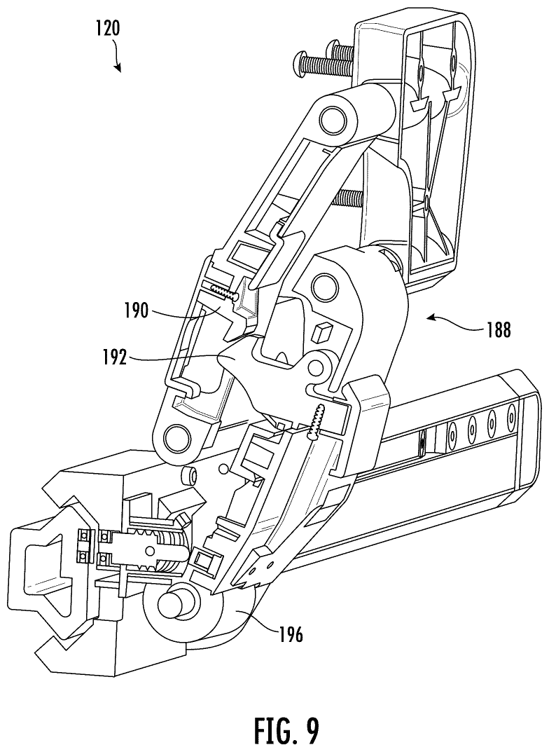

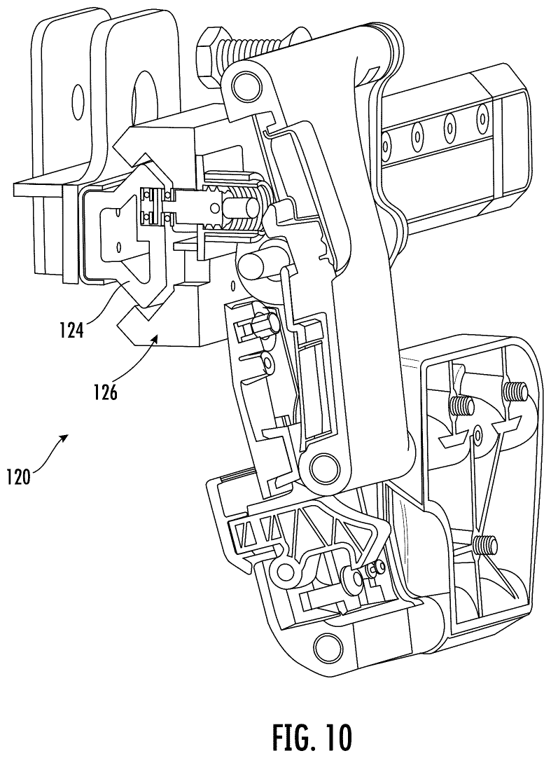

Referring to FIGS. 8-10, in an embodiment of the disclosed subject matter, a cross-sectional view of the side rail assemblies 120 is illustrated in a locked position (shown in FIG. 8) or an unlocked position (shown in FIGS. 9-10). The carrier 126 of may include a pair of inner surfaces 172 configured to connect to a pair of outer surfaces 174 of the support rail 124 via a set a rollers (not shown), whereby engagement of the pair of inner surfaces 172 with the pair of outer surfaces 174 limits movement of the carrier 126 relative to the support rail 124 to a sliding movement of the carrier 126 along the support rail 124.

The side rail assemblies 120 may further include a top arm 176 and a bottom arm 178 each rotatably connected to the carrier 126 and configured to support one of the side rails 122. The top arm 176 and the bottom arm 178 may be rotatably connected to the carrier 126 via a first shaft 180 and a second shaft 182 respectively. The side rails 122 may further be rotatably connected to the top arm 176 and the bottom arm 178 via a third shaft 184 and a fourth shaft 186 respectively.

The top arm 176 and the bottom arm 178 form a hinge 188 between the carrier 126 and the side rails 122. The hinge 188 is configured to maintain the side rails 122 in a generally vertical alignment when raised or lowered about the carrier 126.

As illustrated in FIG. 8, the hinge 188 may be locked at a raised position through engagement of a first latch 190 connected to the top arm 176 and a second latch 192 connected to the bottom arm 178. The second latch 192 may be rotated about the bottom arm 178 to disengage the first latch 190 from the second latch 192. Rotation of the second latch 192 to disengage the first latch 190 from the second latch 192 may be accomplished using a pulling member 194, whereby the pulling member 194 is configured to rotate the second latch 192 about the bottom arm 178 and disengage the first latch 190 from the second latch 192. The first latch 190 may be engaged or locked to the second latch 192 when the second latch is urged towards the first latch 190, thereby rotating the second latch 192 relative to the bottom arm 178 until the first latch 190 engages with the second latch 192.

A torsional element 196 may be connected between the carrier 126 and the second shaft 182 to provide rotational resistance of the bottom arm 178 about the second shaft 182 when the first latch 190 is disengaged from the pulling member 194. The torsional element 196 assists in controlling, and more particularly, reducing, a rate of downward movement of the side rails 122 when the side rails 122 are moved from a raised position to a lowered position. In some embodiments the torsional element 196 may be a torsional damper.

As illustrated in FIG. 9, in an embodiment the disclosed subject matter, the first latch 190 is disengaged from the second latch 192 allowing the hinge 188 to swing downwardly with assistance from the torsional element 196.

As illustrated in FIG. 10, in an embodiment the disclosed subject matter, the hinge 188 is in a lowered position allowing the carrier 126 to slide along the support rail 124.

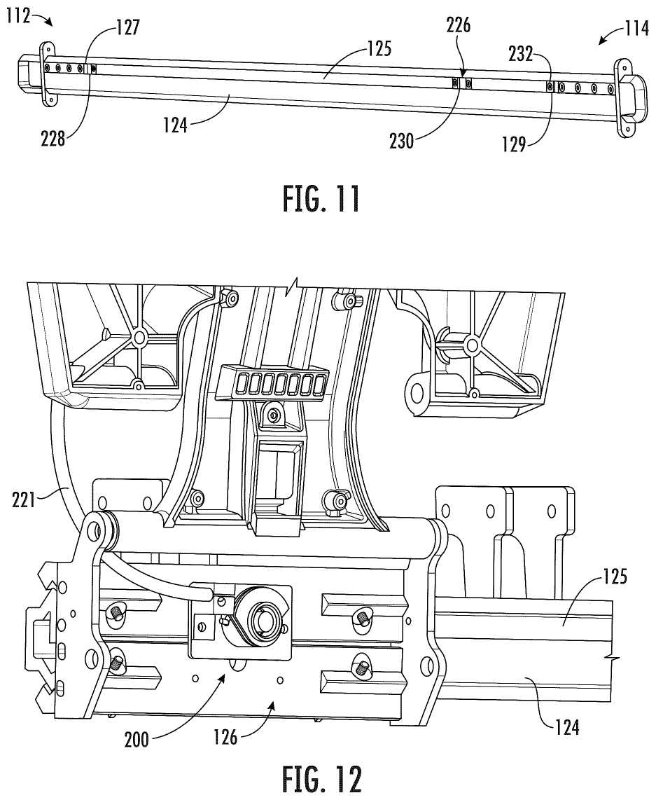

Referring to FIG. 11, in an embodiment the disclosed subject matter, the support rail 124 may comprise a slot 125 running along an exterior surface of the support rail 124. The slot 125 configured to receive at least a portion of a guide pin 222 discussed below. The slot 125 may terminate towards the head end 112 at a first end stop 127; and the slot 125 may terminate towards the foot end 114 at a second end stop 129. The first end stop 127 and second end stop 129 define the extent of travel of the side rail assemblies 120 along the support rail 124 since the guide pin 222 is restrained to movement within the slot 125. The support rail 124 may comprise one or more indents 226 within the slot 125; wherein the one or more indents 226 are configured to receive the guide pin 222 and control the position of a pin body 224 (discussed below) relative to the support rail 124. In an embodiment, the one or more indents 226 may comprise at least one of a head indent 228 positioned adjacent the first end stop 127, an intermediate indent 230 positioned between the first end stop 127 and the second end stop 129, and a foot indent 232 positioned adjacent to the second end stop 129.

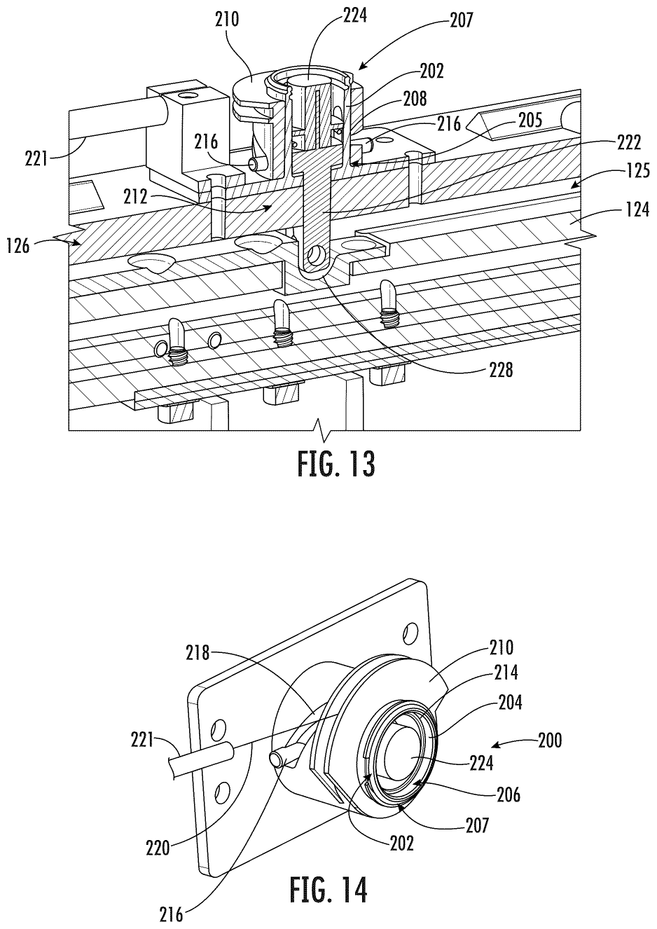

Referring to FIGS. 12-14, in an embodiment of the disclosed subject matter, the side rail assemblies 120 may include a lock assembly 200 comprising a hub 202 having an interior surface 204 defining a central aperture 206 therethrough, wherein the hub 202 being generally cylindrical in shape. The hub 202 having a first end 205 proximate the carrier 126, and a second end 207 opposite the first end 205. The hub 202 may be connected to the carrier 126 opposite the support rail 124. The lock assembly 200 may further comprise an exterior surface 208 of the hub 202 and a rotor 210 rotatably connected to the hub 202 proximate the exterior surface 208. The lock assembly 200 may further comprise a pin assembly 212 extending through the central aperture 206 and movable relative to the hub 202. A spring 214 may positioned between the interior surface 204 and the pin assembly 212; wherein the spring 214 urges the pin assembly 212 towards the carrier 126. The pin assembly 212 may comprise a pair of guide members 216 extending through the hub 202 and the rotor 210. The pair of guide members 216 may be positioned within a pair of helical slots 218 disposed along the periphery of the rotor 210. The pair of helical slots 218 configured to rotate the pin assembly 212 while simultaneously moving the pin assembly 212 through the central aperture 206 when the rotor 210 is rotated, thereby moving the pin assembly 212 outwardly and away from the carrier 126. In an embodiment, a pair of ramps (not shown) may be provided to function in place of the pair of helical slots 218. The pair of ramps configured to move pin assembly 212 over the ramps and through the central aperture 206 when the rotor 210 is rotated, thereby moving the pin assembly 212 outwardly and away from the carrier 126. In an embodiment, a second spring (not shown) is configured to rotate the rotor 210 and urge the pin assembly 212 towards carrier 126. The position of the rotor 210 about the exterior surface 208 is configured to control the position of the pin assembly 212 within the hub 202. When the rotor 210 is rotated, the spring 214 is compressed, and the pair of guide members 216 urges the pin assembly 212 away from the support rail 124 and outwardly through the hub 202. The rotor 210 may be rotated by a cable 220 (not shown) connected between the side rails 122 and the rotor 210 as discussed below.

The pin assembly 212 may comprise a guide pin 222 extending through the hub 202 and the carrier 126. The pin assembly 212 may further comprise a pin body 224 opposite the guide pin 222. The position of the guide pin 222 relative to the hub 202 controls the position of the pin body 224 relative to the hub 202. The guide pin 222 is configured to abut the support rail 124 so that the lateral position of the pin body 224 relative to the support rail 124 may vary depending on surface features of the support rail 124.

In an embodiment, the one or more indents 226 comprise a predetermined depth below the exterior surface of the slot sufficient to receive the at least a portion of the guide pin 222. When at least a portion of the guide pin 222 is received within the one or more indents 226, the pin body 224 does not extend beyond the second end 207 of the hub 202; thereby allowing sufficient upward rotation of the bottom arm 178 so the first latch 190 locks with the second latch 192. In an embodiment, when the lock assembly 200 is centered over an indent, the spring 214 may urge the guide pin 222 into the one or more indents 226; thereby adjusting the position of the pin body 224 relative to the hub 202.

When the guide pin 222 is not received within the one or more indents 226, the pin body 224 is urged outwardly from the hub 202 through the second end 207; thereby preventing sufficient upward rotation of the bottom arm 178, and thus preventing the first latch 190 from locking with the second latch 192. As such, when the carrier 126 is positioned between the one or more indents 226, the side rails 122 may not be locked in a raised position.

In an embodiment, when at least a portion of the guide pin 222 is received within one of the one or more indents 226, side rails 122 may locked in a raised position and the carrier 126 cannot be moved along the support rail 124. When one of the side rails 122 is moved to a lowered position and the guide pin 222 is urged out of the one or more indents 226 through rotation of the rotor 210, the carrier 126 freely slide along the support rail 124.

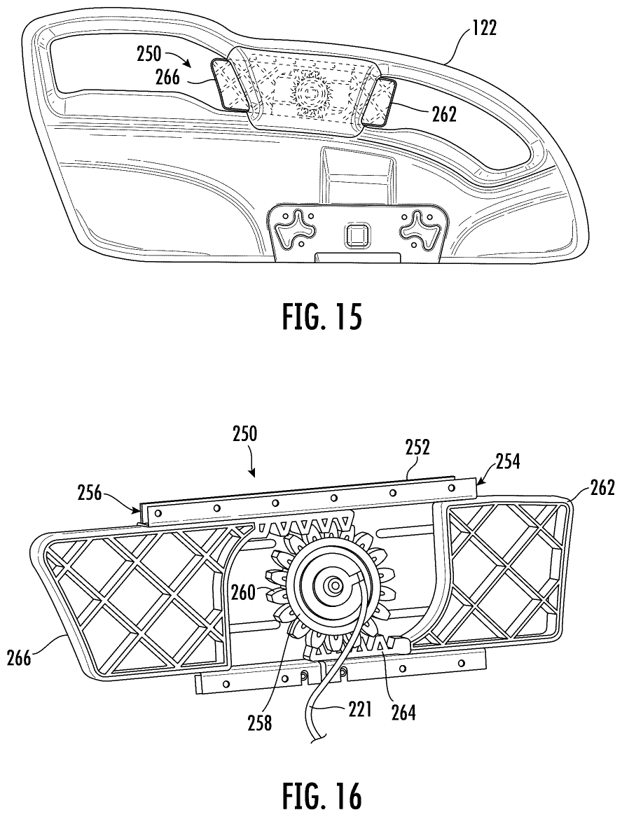

Referring to FIGS. 15-16, in an embodiment of the disclosed subject matter, the side rails 122 may comprise a paddle assembly 250 configured to unseat the guide pin 222 from the one or more indents 226; thereby allowing movement of the side rails 122 and carrier 126 along the support rail 124. In an embodiment, the paddle assembly 250 comprises: a frame 252 coupled to one of the side rails 122, the frame 252 having a first frame end 254 and a second frame end 256 opposite the first frame end 254; a central gear 258 connected to the frame 252, the central gear 258 having a set of teeth 260 disposed along the circumference of the central gear 258; a first paddle 262 having a first gear rack 264 configured to engage the set of teeth 260, the first paddle 262 slidably coupled to the frame 252 at the first frame end 254; a second paddle 266 having a second gear rack 268 configured to engage the set of teeth 260 opposite the first gear rack 264, the second paddle 266 slidably coupled to the frame 252 at the second frame end 256. In an embodiment, the central gear 258 includes a rotating element (not shown), such as a torsion spring or an axial spring, configured to urge rotation of the central gear 258 so that the first paddle 262 and the second paddle 266 are urged away from each other via linear movement of the first gear rack 264 and second gear rack 268.

In an embodiment, a cable 220 may be enclosed within a sheath 221 and connected between the central gear 258 and the rotor 210; whereby rotation of the central gear 258 moves the cable 220 and rotates the rotor 210; thereby unseating the guide pin 222 from the one or more indents 226 and allowing for movement of the carrier 126 along the support rail 124. In an embodiment, a cable tensioning element (not shown) is located between the central gear 250 and the rotor 210. The cable tensioning element may be configured to adjust the tension of the cable 220 between the central gear 258 and the rotor 210.

If one of the side rails 122 is in a lowered position (166,168,170), a user may unseat the side rails 122 from the one or more indents 226 by pushing on one of the first paddle 262 or the second paddle 266. Movement of the first paddle 262 and/or the second paddle 266 results in rotation of the central gear 258 via engagement of the set of teeth 260 with one of the first gear rack 264 and/or the second gear rack 268. Rotation of the central gear 258 moves the cable 220 through the sheath 221, and, in turn, rotates the rotor 210, thereby moving the guide pin 222 of the pin assembly 212 out of the one or more indents 226.

In an embodiment, if a user desires to move one of the side rails 122 towards the foot end 114, provided the one of the side rails 122 is in a lowered position, the user may push the first paddle 262 towards the foot end 114, whereby the rotation of the central gear 258 urges the cable 220 to rotate the rotor 210, thereby unseating the guide pin 222 from the one or more indents 226. If the user continues to push the first paddle 262 towards the foot end 114 after unseating the guide pin 222, the carrier 126 will slide along the support rail 124 towards the foot end 114.

In a similar manner, if a user desires to move one of the side rails 122 towards the head end 112, provided the one of the side rails 122 is in a lowered position, the user may push the second paddle 266 towards the head end 112, whereby the rotation of the central gear 258 urges the cable 220 to rotate the rotor 210, thereby unseating the guide pin 222 from the one or more indents 226. If the user continues to push the second paddle 266 towards the head end 112 after unseating the guide pin 222, the carrier 126 will slide along the support rail 124 towards the head end 112.

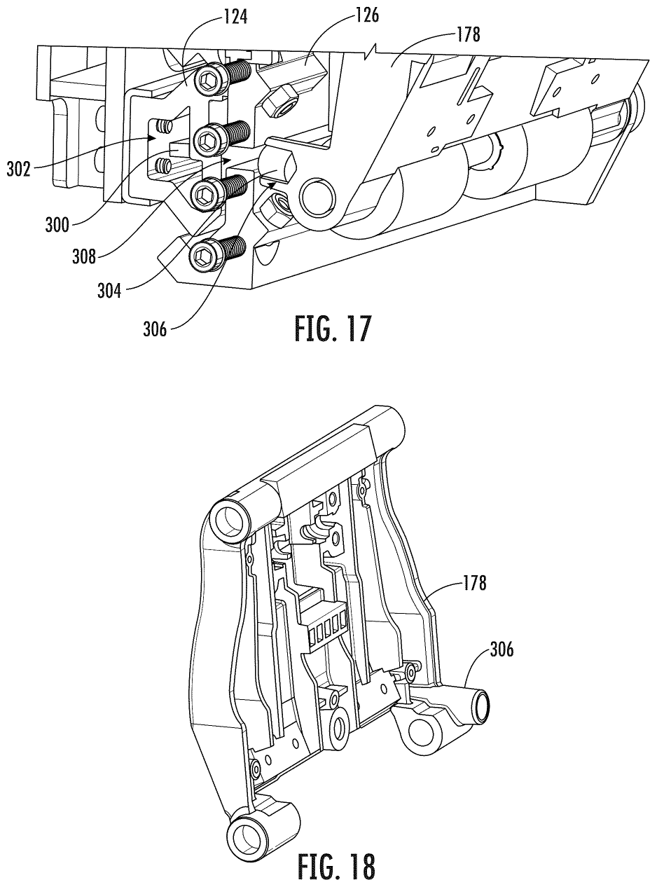

Referring to FIGS. 17-18, in an embodiment of the disclosed subject matter, a magnetic sensor 300 may be connected to the support rail 124 to confirm the position of the bottom arm 178, and more specifically to confirm whether the bottom arm 178 is locked to the top arm 176 when one of the side rails 122 is in the one of the raised head position 160, the raised intermediate position 162, or the raised foot position 164.

In an embodiment, the magnetic sensor 300 may be connected to the support rail 124. In an embodiment, a plurality of magnetic sensors 300 may be connected to the support rail 124 at positions corresponding to the head indent 228, the intermediate indent 230, or the foot indent 232. Additional magnetic sensors may be provided corresponding to additional indent positions depending on the application. In an embodiment, the magnetic sensor 300 is connected to the support rail 124 within an interior space 302 of the support rail 124. In another embodiment, the magnetic sensor 300 may be located partially within the support rail 124. In an embodiment, the magnetic sensor 300 may be configured to detect a magnetic field source 304 connected to the carrier 126.

In an embodiment, the magnetic sensor 300 may comprise a magnetic proximity sensor such as, by way of example, a ZF Electronics model MP201801 sensor.

In an embodiment, the magnetic sensor 300 is triggered when a magnetic field source 304 is brought into proximity of the magnetic sensor 300. In an embodiment, the magnetic field source 304 is configured to trigger the magnetic sensor 300 when located within approximately 1 inch of the magnetic sensor 300. In an embodiment, the magnetic field source 304 may comprise a N52 magnet, or another suitable magnet type configured to trigger the magnetic sensor 300. In an embodiment, the magnetic field source 304 may be cylindrical in shape and may have a diameter of ⅜ inches and a length of ⅜ inches. The magnetic field source 304 may be connected to the bottom arm 178 of the side rail assemblies 120. The bottom arm 178 may comprise a housing 306 for connecting the magnetic field source 304 to the bottom arm 178. The magnetic field source 304 is configured to trigger the magnetic sensor 300 when the bottom arm 178 is locked to the top arm 176, indicating that one of the side rails 122 is in one of the raised head position 160, the raised intermediate position 162, or the raised foot position 164. In an embodiment, a gap 308 is disposed through the carrier 126 to assist with the transmission of a magnetic field generated by the magnetic field source 304 through the carrier 126. The gap 308 is located proximate the magnetic field source 304 when the bottom arm 178 is in a raised position.

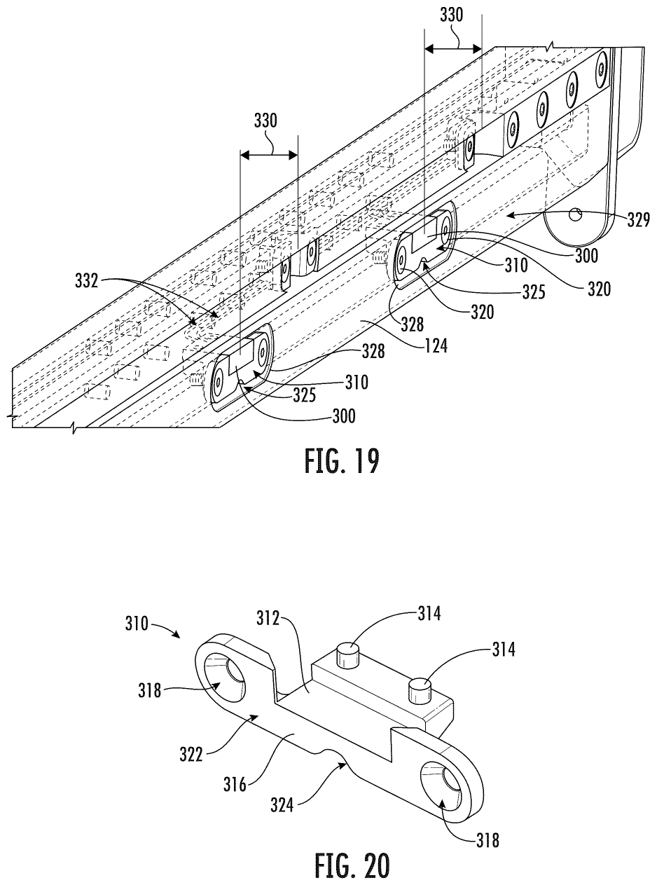

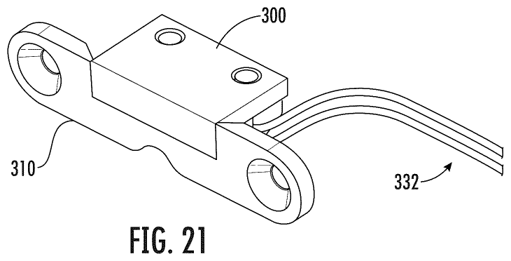

Referring to FIGS. 19-21, in an embodiment of the disclosed subject matter, the magnetic sensor 300 may be recessed into the support rail 124. The magnetic sensor 300 may be connected to a support bracket 310, wherein the support bracket 310 may comprise a support body 312 configured to abut and support the magnetic sensor 300; a plurality of alignment members 314 configured to position the magnetic sensor 300 with the support body 312; and a front member 316 connected to the support body 312. The plurality of alignment members 314 may comprise a pair of posts extending upwardly from the support body 312. The front member 316 may comprise a pair of holes 318 for accepting mounting hardware 320 such as machine screws or the like for connecting the support bracket 310 to the support rail 124. In an embodiment, the holes 318 may be tapered so the mounting hardware 320 may be secured flush with a front face 322 of the front member 316. In an embodiment, the front member 316 may comprise a notch 324 extending from the front member 316 towards the support body 312. The notch 324 configured to assist in the alignment and orientation of the magnetic sensor 300 with the support rail 124. The support rail 124 may comprise a rail extension 325 configured to abut the notch 324. The magnetic sensor 300 may be positioned flush with the front face 322 of the support bracket 310.

In an embodiment, the magnetic sensor 300 may comprise a pair of electrical connectors 332 which may be routed within the interior space 302 (see FIG. 17) of the support rail 124.

In an embodiment, the support rail 124 may comprise one or more protective covers 328 configured to protect the magnetic sensor 300 from environmental contamination such as debris or fluids. The one or more protective covers 328 may be connected to an exterior surface 329 of the support rail 124 by means of adhesives or other suitable means of connection. The one or more protective covers 328 may comprise a sticker configured to create an environmental seal along the exterior surface 329 of the support rail 124 to protect the magnetic sensor 300.

In an embodiment, the magnetic sensor 300 is positioned a predetermined distance 330 from the one or more indents 226 in order to align the magnetic field source 304 with the magnetic sensor 300 when the guide pin 222 engages the one or more indents 226.

### Methods of Use

In an embodiment, a method for moving a side rail may comprise the steps of: (1) proving a medical bed having a support rail connected to at least one side of an upper frame of the medical bed; (2) providing a side rail assembly connected between the support rail and side rail; wherein the slide rail assembly comprises a carrier slidably coupled to the support rail, and a pin assembly having a guide pin configured to abut the support rail; wherein the support rail comprises one or more indents configured to receive the guide pin; (3) aligning the guide pin with one of the one or more indents; thereby urging the guide pin into one of the one or more idents; and (4) raising a hinge connected to the carrier, whereby the side rail is moved to a raised position. The method for moving the side rail may further comprise the step of engaging a first lock with a second lock, thereby locking the side rail in a raised position.

In an embodiment, a method for moving a side rail may further comprise the steps of: (1) moving a pulling member connected to a second latch; (2) disengaging a first latch from the second latch; and (3) rotating a hinge downwardly, whereby the side rail is moved to lowered position. In an embodiment, the method for lowering a side rail may further comprise the step of rotating a torsional element connected to the hinge. In an embodiment, the torsional element may be a torsional damper for controlling the rate of downward movement of the side rail from the raised position to the lowered position.

In an embodiment, the method for moving a side rail may further comprise the steps of: (1) moving a pin assembly out of the one or more indents; (2) pushing the side rail towards one of a head end and a foot end of the medical bed; and (3) sliding a carrier along the support rail, thereby moving a side rail. The method of moving the side rail may further comprise the step of rotating the pin assembly within a helical slot, thereby moving the pin assembly out of the one or more indents. The method of moving the side rail may further comprise the step of rotating a rotor having a helical slot configured to urge the pin assembly out of the one or more indents. The method of moving the side rail may further comprise the step of providing a central gear having a cable connected to the rotor; and rotating the central gear, thereby urging the cable to rotate the rotor and move the pin assembly out of the one or more indents. The method for moving a side rail may further include the steps of: (1) providing a first paddle having a first gear rack linked to the central gear; (2) providing a second paddle having a second gear rack linked to the central gear; (3) moving one of the first paddle and the second paddle towards the central gear, thereby rotating the central gear.

A method of triggering a magnetic sensor may comprise the steps of: (1) providing a support rail having magnetic sensor; providing a carrier connected to the support rail, wherein the carrier comprises a gap proximate the magnetic sensor; providing a bottom arm rotatably connected to the carrier, wherein the carrier includes a magnetic field source configured to rotate with bottom arm; aligning the carrier with the magnetic sensor; rotating the bottom arm, thereby aligning the magnetic field source, gap, and magnetic sensor; and triggering the magnetic sensor with the magnetic field source.

It is to be understood that while certain aspects of the disclosed subject matter have been shown and described, the disclosed subject matter is not limited hereto and encompasses various other embodiments as aspects.

Having described the disclosed subject matter, what is claimed as new and desired to be secured by Letters Patent is:

1. A side rail assembly for a medical bed comprising:
a support rail connected to the medical bed, the support rail comprising:
a slot disposed along an exterior surface the support rail; and
one or more indents positioned within the slot;
a carrier slidably connected to the support rail, the carrier comprising a guide pin configured to slidably abut the slot; and
a side rail connected to the carrier,
wherein the guide pin is urged into the one or more indents when the guide pin is aligned with the one more indents, thereby allowing rotation of the side rail to a raised position and restricting movement of the carrier along the support rail.

2. The side rail assembly of claim 1, further comprising a hinge connected between the carrier and the side rail, the hinge configured to rotate between a raised position and a lowered position.

3. The side rail assembly of claim 2, wherein the hinge comprises:
a top arm having a first latch; and
a bottom arm having a second latch rotatably connected to the bottom arm,
wherein the second latch is configured to engage the first latch when the hinge is rotated into the raised position.

4. The side rail assembly of claim 3, the hinge further comprises a pulling member configured to rotate the second latch away from the first latch.

5. The side rail assembly of claim 3, wherein a torsional element is connected between the carrier and the bottom arm, wherein the torsional element is configured to provide rotational resistance of the hinge when the hinge is moved from the raised position to the lowered position.

6. The side rail assembly of claim 2, further comprising a lock assembly comprising:
a hub connected to the carrier, the hub having a central aperture;
a rotor rotatably connected to an exterior surface of the hub, the rotor having one of a pair of helical slots and a pair of ramps;
a pin assembly extending through the central aperture, the pin assembly configured to engage one of the pair of helical slots and the pair of ramps, whereby the rotation of the rotor about the hub moves the pin assembly within the hub outwardly and away from the carrier; and
a spring configured to urge the pin assembly towards the carrier.

7. The side rail assembly of claim 6, wherein the rotation of the rotor is configured to compress the spring.

8. The side rail assembly of claim 6, wherein the lock assembly further comprises a pin body connected to the guide pin within the hub, wherein when the hinge is prevented from rotating to the raised position when the guide pin is not aligned with the one or more indents.

9. The side rail assembly of claim 6, wherein the side rail comprises a paddle assembly configured to rotate the rotor and unseat the guide pin from the one or more indents, thereby allowing movement of the carrier along the support rail.

10. The side rail assembly of claim 9, wherein the paddle assembly comprises:
a frame coupled the side rail, the frame having a first frame end and a second frame end opposite the first frame end;
a central gear connected to the frame, the central gear having a set of teeth disposed along a circumference of the central gear;
a first paddle having a first gear rack configured to engage the set of teeth, the first paddle slidably coupled to the frame at the first frame end;
a second paddle having a second gear rack configured to engage the set of teeth opposite the first gear rack, the second paddle slidably coupled to the frame at the second frame end; and
a cable connected between the central gear and the rotor, whereby rotation of the central gear urges rotation of the rotor,
whereby movement of one of the first paddle and the second paddle rotates the central gear.

11. The side rail assembly of claim 10, wherein the paddle assembly further comprises a rotating element configured to urge rotation of the central gear.

12. The side rail assembly of claim 11, wherein the rotating element comprises one of a torsion spring and an axial spring.

13. The side rail assembly of claim 1, further comprising a magnetic sensor recessed into the support rail, the magnetic sensor configured to detect a magnetic field source connected to the carrier.

14. The side rail assembly of claim 13, wherein the magnetic sensor is positioned a predetermined distance from the one or more indents.

15. The side rail assembly of claim 10, further comprising cable tensioning element configured to adjust the tension of the cable between the central gear and the rotor.

16. A side rail assembly for a medical bed comprising:
a support rail connected to the medical bed, the support rail comprising:
a slot disposed along an exterior surface the support rail; and
one or more indents positioned within the slot;
a carrier slidably connected to the support rail, the carrier comprising a guide pin configured to slidably abut the slot; and
a side rail connected to the carrier,
wherein the guide pin is urged into the one or more indents when the guide pin is aligned with the one more indents, thereby restricting movement of the carrier along the support rail.

17. The side rail assembly of claim 16, further comprising a lock assembly comprising:
a hub connected to the carrier, the hub having a central aperture;
a rotor rotatably connected to an exterior surface of the hub, the rotor having one of a pair of helical slots and pair of ramps;
a pin assembly extending through the central aperture, the pin assembly configured to engage one of the pair of helical slots and the pair of ramps, whereby rotation of the rotor about the hub moves the pin assembly within the hub outwardly and away from the carrier; and
a spring configured to urge the pin assembly towards the carrier.

18. The side rail assembly of claim 17, wherein the rotation of the rotor is configured to compress the spring.

19. The side rail assembly of claim 18, wherein the side rail comprises a paddle assembly configured to rotate the rotor and unseat the guide pin from the one or more indents, thereby allowing movement of the carrier along the support rail.

20. The side rail assembly of claim 19, wherein the paddle assembly comprises:
a frame coupled the side rail, the frame having a first frame end and a second frame end opposite the first frame end;
a central gear connected to the frame, the central gear having a set of teeth disposed along a circumference of the central gear;
a first paddle having a first gear rack configured to engage the set of teeth, the first paddle slidably coupled to the frame at the first frame end;
a second paddle having a second gear rack configured to engage the set of teeth opposite the first gear rack, the second paddle slidably coupled to the frame at the second frame end; and
a cable connected between the central gear and the rotor, whereby rotation of the central gear urges rotation of the rotor,
whereby movement of one of the first paddle and the second paddle rotates the central gear.

21. The side rail assembly of claim 20, wherein the paddle assembly further comprises a rotating element configured to urge rotation of the central gear.

22. The side rail assembly of claim 21, wherein the rotating element comprises one of a torsion spring and an axial spring.

23. A method for moving a side rail, comprising the steps of;
providing a medical bed having a support rail connected to at least one side of an upper frame of the medical bed;
providing a side rail assembly connected between the support rail and a side rail, wherein the side rail assembly comprises a carrier slidably coupled to the support rail;
providing a pin assembly having a guide pin configured to abut the support rail, wherein the support rail comprises one or more indents configured to receive the guide pin;
aligning the guide pin with one of the one or more indents, thereby urging the guide pin into one of the one or more indents; and
raising a hinge connected to the carrier, whereby the side rail is moved to a raised position.

24. The method for moving a side rail of claim 23, further comprising the step of engaging a first latch with a second latch, thereby locking the side rail in the raised position.

25. The method for moving a side rail of claim 24, further comprising the steps of:
moving a pulling member connected to the second latch;
disengaging the first latch from the second latch; and
rotating a hinge downwardly from the raised position to a lowered position.

26. The method for moving a side rail of claim 25, further comprising the step of rotating a torsional element connected to the hinge.

27. The method for moving a side rail of claim 26, wherein the torsional element is a torsional damper, configured to control a rate of downward movement of the side rail from the raised position to the lowered position.

28. The method for moving a side rail of claim 25, further comprising the steps of:
moving the pin assembly out of the one or more indents; and
pushing the side rail towards one of a head end and a foot end of the medical bed.

29. The method for moving a side rail of claim 28, further comprising the step of rotating a rotor having one of a helical slot and a ramp configured to urge the pin assembly out of the one or more indents.

30. The method for moving a side rail of claim 29, further comprising the steps of:
providing a central gear connected to the side rail, the central gear having a cable connected to the rotor; and
rotating the central gear, thereby urging the cable to rotate the rotor and move the pin assembly out of the one or more indents.

31. The method for moving a side rail of claim 30, further comprising the steps of:
providing a first paddle having first gear rack linked to the central gear;
proving a second paddle having a second gear rack linked to the central gear; and
moving one of the first paddle and the second paddle towards the central gear, thereby rotating the central gear.

32. A method of triggering a magnetic sensor, comprising the steps of:
providing a support rail having a magnetic sensor;
providing a carrier connected to the support rail, wherein the carrier comprises a gap proximate the magnetic sensor;
providing a bottom arm rotatably connected to the carrier, wherein the carrier includes a magnetic field source configured to rotate with the bottom arm;
aligning the carrier with the magnetic sensor;
rotating the bottom arm, thereby aligning the magnetic field source, the gap, and the magnetic sensor; and
triggering the magnetic sensor with the magnetic field source.

33. A side rail assembly for a medical bed comprising:
a support rail connected to the medical bed;
a side rail slidably connected to the support rail; and
wherein the side rail is configured to transition from a head position to a foot position in a linear motion.

34. The side rail assembly of claim 33, wherein the side rail is configured to transition from the foot position to the head position in a linear motion.
